(19) United States
(12) Patent Application Publication
(10) Pub. No.: US 2004/0266362 A1
(43) Pub. Date: Dec. 30, 2004

(54) Transmit/receive switch

(76) Inventors: Ronald Dean Watkins, Niskayuna, NY (US); Douglas Arthur Charles Kelley, Rockville, MD (US)

Correspondence Address: GENERAL ELECTRIC COMPANY, GLOBAL RESEARCH, PATENT DOCKET RM. BLDG. K1-4A59, NISKAYUNA, NY, 12309, US

(21) Appl. No.: 10/609,799

(22) Filed: Jun. 27, 2003

(51) Int. Cl. H04B 1/44

(52) U.S. Cl. 455/78; 455/84

(57) ABSTRACT

A transmit/receive switch for a system operating over a range of frequencies is provided. The switch comprises a pair of quadrature hybrid circuits and a switching means for coupling the pair of circuits. When the switch is operating in a transmit mode, the hybrid circuits provide a low loss path between a transmitter. When the switch is operating in a receive mode, the hybrid circuits provide a high isolation from the RF coil to a pre-amplifier.

### BACKGROUND OF THE INVENTION

The invention relates generally to transmit/receive switches, and more specifically to a transmit/receive switch used for high frequencies.

In many high frequency applications, such as magnetic resonance imaging, it is required to selectively couple between a transmitter path and a receiver path. Typically, the transmitter path couples a transmitter and a radio frequency (RF) coil or antenna when the transmit/receive switch is operating in a transmit mode. Similarly, the receiver path is coupled to the RF coil and the pre-amplifier when the switch is operating in a receive mode.

It is desirable to have a low loss on both the transmitter path and the reception path. Transmit/receive switches are typically employed for such purposes. In addition, high isolation is desired the transmitter path and the receiver path to avoid damages to the receiver It is also desirable while operating in receive mode to have high isolation between the transmitter and the antenna and or receiver to prevent additional noise from the transmitter form entering the receive path.

Typically, transmit/receive switches are designed using semiconductor devices such as pin diodes. One problem with using semiconductor devices is that a transmitted or receive signal gets attenuated when the signal passes through the semiconductor devices. In addition, noise signals are generated due to the passage of signals through semiconductor devices.

Another problem with using semiconductor devices is isolation between the transmitter and the receiver. At high frequencies, many semiconductor devices such as pin diodes offer low isolation between the transmitter path and the receiver path. The low isolation can lead to the damage of a receiver on the receiver path due to the transmission of large electrical signal transmitted on the transmitter path. Another problem with simple non-resonant semiconductor switch occurs when the semiconductor is back biased and turned off, the junction capacitance may result in poor isolation.

It would therefore be desirable to implement a transmit/receive switch having a low loss path during the transmit mode and the receive mode and also provide high isolation between the transmitter and the receiver.

### BRIEF DESCRIPTION OF THE INVENTION

Briefly, in accordance with one embodiment of the invention, a transmit/receive (T/R) switch for a system operating over a range of frequencies is provided. The T/R comprises a pair of quadrature hybrid circuits and a switching means for coupling the pair of circuits. The hybrid circuits provide a low loss path between a transmitter and a radio frequency (RF) coil when the switch is operating in a transmit mode and a high isolation from the transmitter to a preamplifier when the switch is operating in a receive mode.

In further embodiments, a method for implementing a transmit and receive switching capability for a system which is operational is provided. The method comprises providing a switching means for coupling a pair of quadrature hybrid circuits, wherein the hybrid circuits provide a low loss path between a transmitter and a radio frequency (RF) coil when the switch is operating in a transmit mode and providing a high isolation from the transmitter to a pre-amplifier when the switch is operating in a receive mode.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a transmit/receive switch employing shunt switches;

FIG. 2 is a block diagram of an alternate embodiment of a transmit/receive switch employing series switches

FIG. 3 is a circuit diagram one embodiment of transmit/receive switch;

FIG. 4 is a circuit diagram an alternate embodiment of transmit/receive switch; and

FIG. 5 is a block diagram of an embodiment of a high field magnetic resonance imaging (MRI) system implemented according to an aspect of the invention.

### DETAILED DESCRIPTION OF THE INVENTION

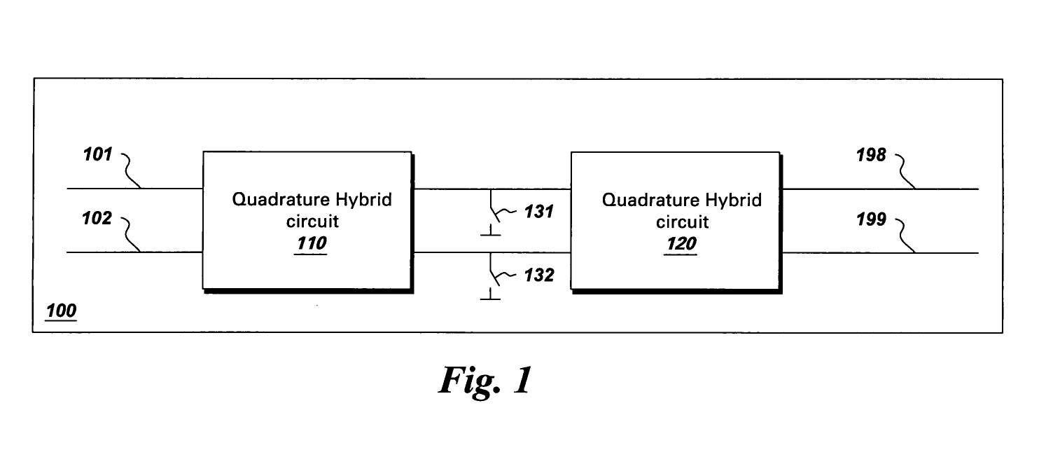

FIG. 1 is a block diagram of one embodiment of transmit/receive (T/R) switch 100 implemented according to the invention. T/R switch 100 comprises quadrature hybrid circuits 110 and 120, and switches 131 and 132. Each component is described in detail below. As shown in FIG. 1, T/R switch is adapted to be used in a variety of applications well known to one skilled in the art that may need a T/R switch, for example in high field magnetic resonance imaging systems.

As used herein, “adapted to”, “configured” and the like refer to mechanical or structural connections between elements to allow the elements to cooperate to provide a described effect; these terms also refer to operation capabilities of electrical elements such as analog or digital computers or application specific devices (such as an application specific integrated circuit (ASIC)) that are programmed to perform a sequel to provide an output in response to given input signals.

Transmit/receive switch 100 operates in two modes, namely a transmit mode and a receive mode. In the transmit mode, a radio frequency (RF) coil is coupled to a transmitter. In the receive mode, the RF coil is coupled to a pre-amplifier.

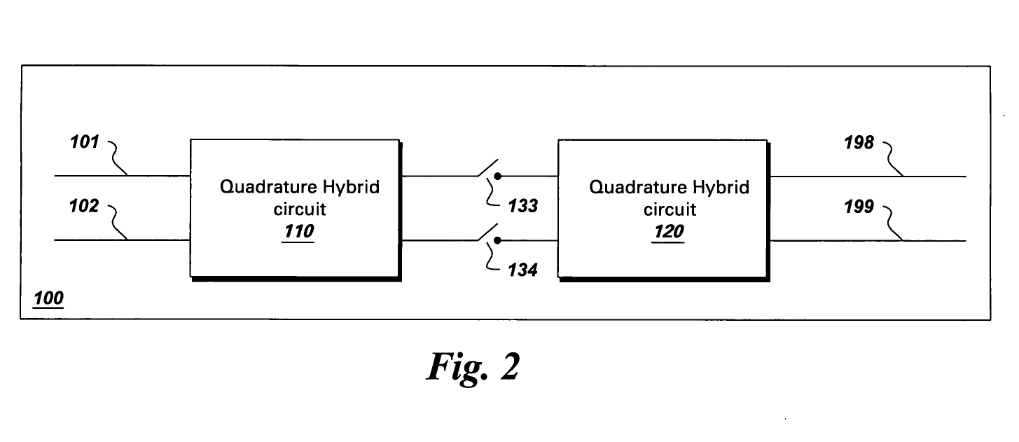

Quadrature hybrid circuits 110, 120 are coupled together in using shunt switches 131 and 132. In another embodiment shown in FIG. 2, the quadrature hybrid circuits are coupled together using series switches 133 and 134. In one embodiment, the switches comprise pin diodes.

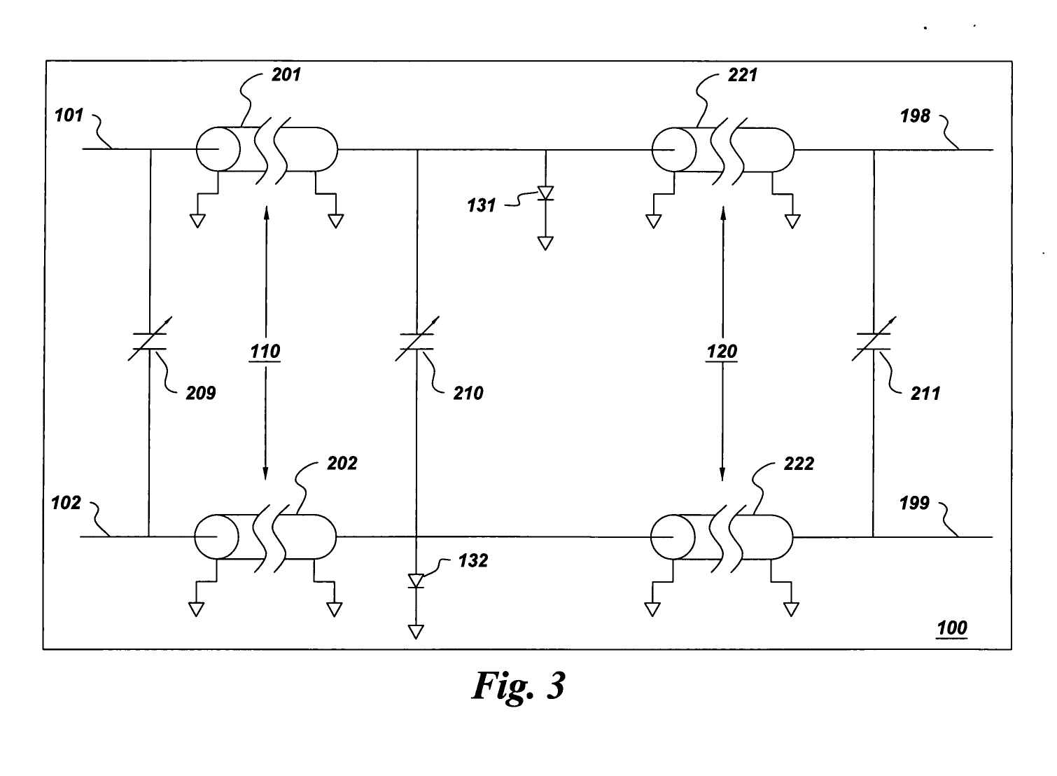

Quadrature hybrid circuits 110 and 120 can be of many different forms such as lumped element quasi-lumped element. In another embodiment, the quadrature hybrid circuits 110 and 120 can be high pass, low pass or band pass. In an embodiment, the quadrature hybrid circuits 110 and 120 comprise non-magnetic capacitors, inductors or transmission line. In another embodiment, the quadrature hybrid circuits 110 and 120 comprise magnetic or non-ferrous cores. In one embodiment (as will be described in further detail with reference to FIG. 3), the quadrature hybrid circuits 110 and 120 comprise a pair of eighth wavelength transmission lines and a plurality of capacitors. In an alternate embodiment, the quadrature hybrid circuits 110 and 120 comprise broadband transformers or magnetically coupled inductors hybrids.

One skilled in the art will appreciate that the design of the quadrature circuits is generally based upon the operating frequency range. For example, for high frequency applications, transmission lines, striplines or microstrips are used. Similarly, for low frequency application, lumped elements are used.

Quadrature hybrid circuits 110 and 120 provide a low loss path between a transmitter (not shown) and a radio frequency (RF) coil (not shown) when the T/R switch is operating in a transmit mode. In the transmit mode, the pre-amplifier is isolated from the transmitter.

When the T/R switch 100 is operating transmit mode, the switch has a low loss path between RF coil and transmitter and high isolation from transmitter to receiver. In receive mode, the switch provides a low loss path between RF coil and receiver and high isolation from the RF coil and the transmitter.

Transmit/receive switch comprises a first port 101 coupled to the transmitter, a second port 102 coupled to the RF coil. A third port 198 coupled to a receiver channel and a fourth port 199 is typically coupled to impedance (not shown) in well known configurations.

The quadrature hybrid circuits could be quasi-lumped circuits or branch line hybrids. As described above, the quadrature hybrid circuits can be designed using elements such as lumped elements, co-axial transmission lines, microstrips and waveguides. The circuit topology used for designing the hybrid circuits is based on the transmitted power and the frequency of operation.

FIG. 3 is a circuit diagram one embodiment of transmit/receive switch 100. Quadrature hybrid circuits 110 and 120 each comprise two semi-rigid coaxial transmission lines 201, 202 and 221, 222 respectively.

The coaxial lines minimize losses at high frequencies when the transmit/receive switch is operating in the transmit mode or receive mode. Capacitors 209, 210 and 211 are adjusted to achieve minimum losses and maximum isolation.

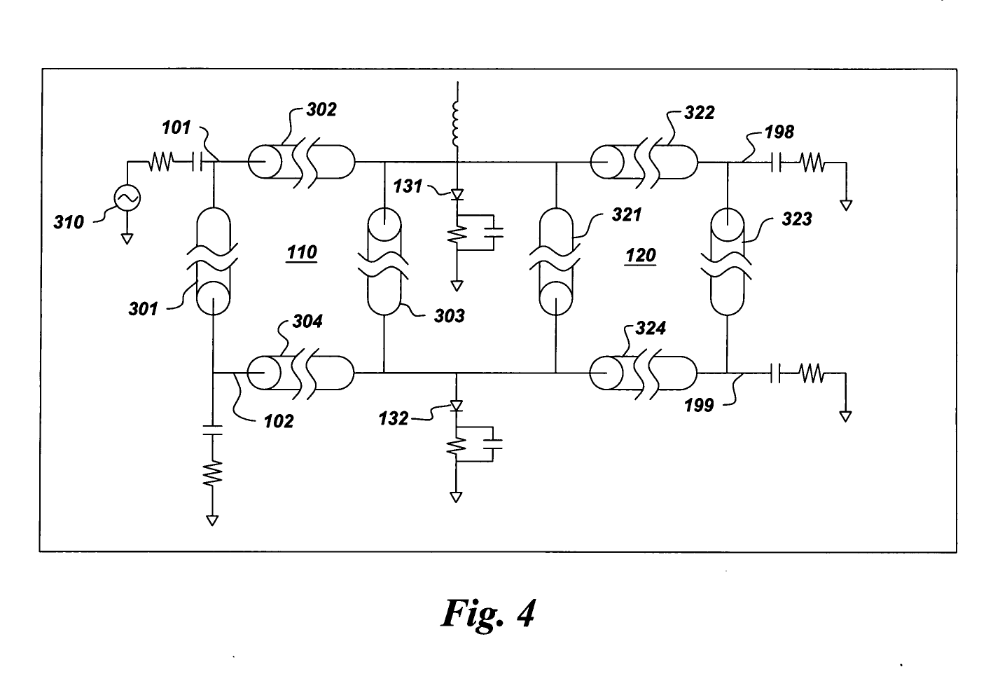

FIG. 4 is a circuit diagram of an alternate embodiment of transmit/receive switch 100. Quadrature hybrid circuits 110 and 120 each comprise four quarter Wave transmission lines 301, 302, 303 and 304 and 321,322, 323 and 324 respectively. Transmit/receive switch further comprise two diode switches 131 and 132. Port 101 is coupled to power amplifier 310. In one embodiment, a 447V power amplifier is used. Transmission lines are 301, 303, 321 and 323 are at a first characteristic impedance and transmission lines 302, 304, 322 and 324 are at a second characteristic impedance. In an embodiment, the second characteristic impedance equals the first characteristic impedance divided by the square root of two.

In one embodiment, the transmit loss is below 0.2 dB and the pre-amplifier isolation is 65 dB, when the transmit/receive switch operates at 300 MHz. When the T/R switch is operating in the receive mode, the transmitter isolation is 35 dB and the receive loss is 0.15 dB.

The transmit/receive switch can be designed to operate in different frequency and power ranges. The center frequency may vary between 5 MHz and 1000 MHz. The power ranges from 1 W to 50 KW.

In one embodiment, the switch is designed using non-magnetic components and therefore is adapted to operate in high magnetic fields. For example, the transmit/receive switch can be used in a high field magnetic resonance imaging (MRI) system. Generally, high field refers to a magnetic field is greater than about 1.5 Tesla. In another embodiment, the transmit/receive switch is adapted to operate in an MRI system at a magnetic field strength of 7 Tesla. By using transmission lines, the T/R switch can be operated at very high frequencies because of the compact nature of the transmission line.

A method for implementing the transmit/receive switch is described below. It is to be appreciated that there are many applications in which a T/R is used, e.g. MRI systems, radio communications system, RADAR, ultrasound imaging systems or almost any system that switches a transmitter and receiver to a common antenna or transducer. The method described herein can be adapted for use in such systems when there is a need for a low loss path during transmit and receive modes and high isolation between the transmitter and receiver. A switching means is provided for coupling a pair of quadrature hybrid circuits, wherein the combination of the quadrature hybrid circuits and switches (hereinafter “T/R switch”) provides in transmit mode a low loss path between a transmitter and a radio frequency (RF) coil or antenna. In addition, in transmit mode the T/R switch provides high isolation between the transmitter and preamplifier or receiver. In receive mode, the T/R switch provides a low loss path between the RF coil/antenna and pre-amplifier or receiver. In addition, in receive mode, the T/R switch provides high isolation from the transmitter to the preamplifier and from the transmitter to the RF.

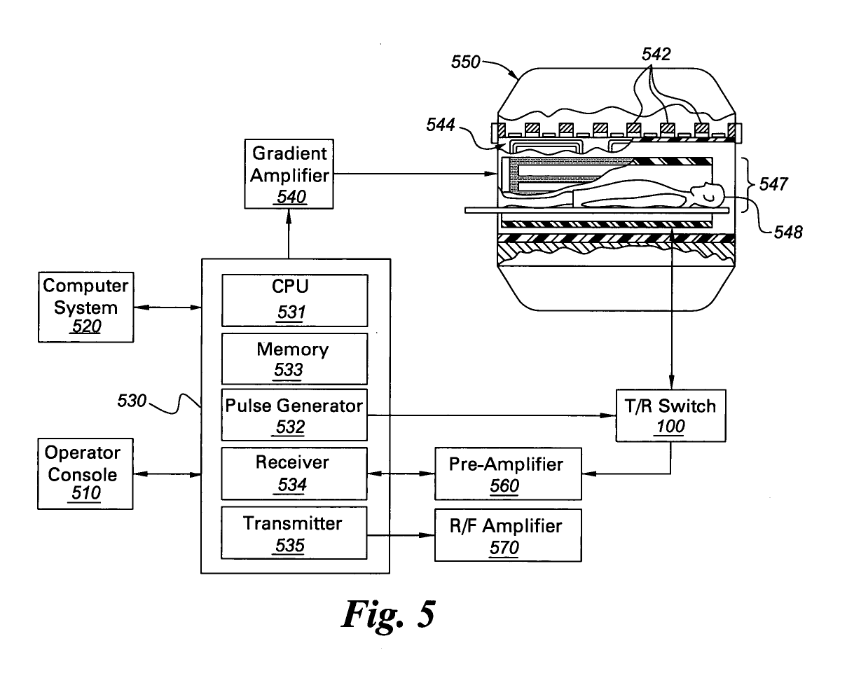

The switching means is used in a plurality of systems that operate for frequency ranges varying from about 5 MHz to 1000 MHz. In another embodiment, the switching means is adapted to operate in a high magnetic field greater than 1.5 Tesla. In a specific embodiment, the high magnetic field is 7 Tesla. The method by which the switching means is implemented in high magnetic field application is described with reference to FIG. 5.

FIG. 5 illustrates a simplified block diagram of a system for producing images to which embodiments of the transmit/receive switch of the present invention are applicable. In the illustrated embodiment of FIG. 5, the system is a MR imaging system which incorporates the present invention. The MRI system could be, for example, a GE-Signa MR scanner available from GE Medical Systems, Inc., which is adapted to perform the method of the present invention, although other systems could be used as well.

The operation of the MR system is controlled from an operator console 510, which includes a keyboard and control panel and a display (not shown). The console 510 communicates with a separate computer system 520 that enables an operator to control the production and display of images. The computer system 520 includes a number of modules, which communicate with each other through a backplane. These include an image processor module, a CPU module, and a memory module, known in the art as a frame buffer for storing image data arrays. The computer system 520 is linked to a disk storage and a tape drive for storage of image data and programs, and it communicates with a separate system control 530 through a high speed serial link.

The system control 530 includes a set of modules connected together by a backplane. These include a CPU module 531 and a pulse generator module 532, which connects to the operator console 510 through a serial link. The system control 530 receives commands from the operator, which indicate the scan sequence that is to be performed. The pulse generator module 532 operates the system components to carry out the desired scan sequence. It produces data that indicate the timing, strength, and shape of the radio frequency (RF) pulses which are to be produced, and the timing of and length of the data acquisition window. The pulse generator module 532 connects to a set of gradient amplifiers 540 to indicate the timing and shape of the gradient pulses to be produced during the scan.

The gradient waveforms produced by the pulse generator module 532 are applied to a gradient amplifier system 540 comprising of Gₓ, G_{y} and G_{z} amplifiers (not shown). Each gradient amplifier excites a corresponding gradient coil in an assembly generally designated 544 to produce the magnetic field gradients used for position encoding acquired signals. The gradient coil assembly 544 forms part of a magnet assembly 550 which includes a polarizing magnet 542 and a whole-body RF coil 545. Volume 547 is shown as the area within magnet assembly 550 for receiving subject 548 and includes a patient bore. As used herein, the usable volume of a MRI scanner is defined generally as the volume within volume 547 that is a contiguous area inside the patient bore where homogeneity of main, gradient and RF fields are within known, acceptable ranges for imaging.

A transmitter module 535 in the system control 530 produces pulses that are amplified by an RF amplifier 570 and coupled to the RF coil 545 by a transmit/receive switch 100. The resulting signals radiated by the excited nuclei in the subject 548 may be sensed by the same RF coil 545 and coupled through the transmit/receive switch 100 to a preamplifier 560. The amplified MR signals are demodulated, filtered, and digitized in receiver 534. The transmit/receive switch 100, as described in greater detail above with reference to FIGS. 1-4, is controlled by a signal from the pulse generator module 532 to electrically couple the transmitter 535 to the coil 545 during the transmit mode and to connect the preamplifier 560 to the RF coil during the receive mode.

The MR signals picked up by the RF coil 545 are digitized by the receiver module 535 and transferred to a memory module 533 in the system control 530. When the scan is completed and an entire array of data has been acquired in the memory module 533. An array processor (not shown) operates to Fourier transform the data into an array of image data. These image data are conveyed to the computer system 520 where they are stored. In response to commands received from the operator console 510, these image data may be further processed by an image processor within computer system 520 and conveyed to the operator console 510 and subsequently displayed.

As used herein, the term “very high field” refers to magnetic fields produced by the MRI system that are greater than about 2 Tesla. For embodiments of the invention the high field is desirably 3 Tesla. Also, as used herein, with reference to high field MRI systems, “very high frequency” is considered to be the range of about 64 MHz to about 500 MHz, with a desired range between about 128 MHz and 300 MHz. For embodiments of the invention, the high frequency is desirably at about 128 MHz. Imaging at very high fields and very high frequencies is particularly useful for cardiac, spine and extremity imaging.

The various embodiments of the invention have many advantages, including providing a low loss path for both transmitting and receiving because the signals transmitted and received do not pass through any semiconductor devices. In addition the transmit/receive switch provides high isolation when operating in the transmit mode and the receive mode.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A transmit/receive switch for a system operating over a range of frequencies comprising:
a pair of quadrature hybrid circuits;
a switching means for coupling the pair of circuits;
wherein the hybrid circuits provide a low loss path between a transmitter and a radio frequency (RF) coil when the switch is operating in a transmit mode; and
the hybrid circuits provide a high isolation from the RF coil to a pre-amplifier when the switch is operating in a receive mode.

2. The transmit/receive switch of claim 1, wherein the switching means comprises shunt switches.

3. The transmit/receive switch of claim 1, wherein the switching means comprises series switches.

4. The transmit/receive switch of claim 1, comprising
a first port coupled to the transmitter;
a second port coupled to the RF coil; and
a third port coupled to a receiver channel.

5. The transmit/receive switch of claim 4, further comprising a fourth port coupled to impedance.

6. The transmit/receive switch of claim 1, wherein the quadrature hybrid circuit is selected from the group containing quasi-lumped circuits, branch line hybrids, broadband hybrid circuits and transformer coupled hybrid circuits.

7. The transmit/receive switch of claim 1, wherein the quadrature hybrid circuits are designed using elements selected from the group containing lumped elements, co-axial transmission lines, microstrips and waveguides.

8. The transmit/receive switch of claim 1, wherein the range of frequency ranges from about 5 MHz to 1000 MHz.

9. The transmit/receive switch of claim 1, wherein the transmit/receive switch is adapted to operate in a high magnetic field.

10. The transmit/receive switch of claim 9, wherein the high magnetic field is greater than 2 Tesla.

11. The transmit/receive switch of claim 10, wherein the high magnetic field is 7 Tesla.

12. The transmit/receive switch of claim 1 where the switch is adapted to be used in a high field magnetic resonance imaging (MRI) system.

13. The transmit/receive switch of claim 12, wherein the switch is designed using non-magnetic components.

14. A method for implementing a transmit and receive switching capability for a system operating comprising:
providing a switching means for coupling a pair of quadrature hybrid circuits, wherein the hybrid circuits provide a low loss path between a transmitter and a radio frequency (RF) coil when the switch is operating in a transmit mode; and wherein the hybrid circuits provide a high isolation from the RF coil to a pre-amplifier when the switch is operating in a receive mode.

15. The method of claim 14, wherein the switching means is operated for frequency ranges from about 5 MHz to 1000 MHz.

16. The method of claim 14, wherein the switching means is adapted to operate in a high magnetic field.

17. The method of claim 16, wherein the high magnetic field is greater than 2 Tesla.

18. The method of claim 17, wherein the high magnetic field is 7 Tesla.

19. The method of claim 14 where the switching means is adapted to be used in a high field magnetic resonance imaging (MRI) system.

20. The method of claim 19, wherein the switching means is designed using non-magnetic components.
